(19) United States
(12) Patent Application Publication
(10) Pub. No.: US 2003/0228042 A1
(43) Pub. Date: Dec. 11, 2003

(54) Method and system for preparation of customized imaging atlas and registration with patient images

(76) Inventor: Usha Sinha, Los Angeles, CA (US)

Correspondence Address: Frank J. Bozzo, Esq., DORSEY & WHITNEY LLP, Suite 3400, 1420 Fifth Avenue, Seattle, WA, 98101, US

(21) Appl. No.: 10/165,774

(22) Filed: Jun. 6, 2002

(51) Int. Cl. G06K 9/00

(52) U.S. Cl. 382/131; 382/168; 382/218; 382/294; 382/296; 382/298

(57) ABSTRACT

A method and system are described that generate customizable reference atlases by automatically extracting relevant images from imaging studies of similar patients stored in an atlas database of archived imaging studies. Keying off user input as to the characteristics of the target patient currently under examination, the method and system identify archived volumes of patients images having similar characteristics, identifies relevant images from those collections, and processes those image to equate their intensity, contrast, and/or orientation with relevant target patient images. In addition, the disclosed method and system automatically extract relevant images from the patient's MR and CT imaging studies. Expert rules are used to infer the suspected abnormality and the anatomical location from structured input related to patient presenting condition. The contrast/intensity customized labeled atlas is registered to the patient imaging study to extract the images that contain the area of abnormality identified by the expert rule based system.

### TECHNICAL FIELD

The present invention is directed to analysis of image data generated through imaging technologies such as magnetic resonance imaging and computed tomography scanning. More particularly, the present invention is related to an automated method and system for identifying and structuring relevant reference image data to allow for comparison with image data obtained from a target patient.

### BACKGROUND OF THE INVENTION

Medical imaging techniques, such as computed tomography (“CT”) and magnetic resonance imaging (“MRI”), have become predominant diagnostic tools. In fact, these techniques have become so prevalent that their popular abbreviations, “CT scan” and “MRI,” respectively, have literally become household words. Effective diagnosis of a multitude of medical conditions, ranging from basic sports injuries to the most costly and pressing health care issues of today, including cancer, stroke, and heart disease, would be far more difficult, if not virtually impossible, without these imaging technologies.

These technologies allow medical professionals and researchers to literally see what is happening inside of a patient in great detail without resorting to invasive surgery. Magnetic resonance imaging, for example, generates a series of two- or three-dimensional view (slices) of a patient in any of sagittal, coronal, or axial cross-sectional views. In a series of two dimensional images, a patient's complete internal anatomy and physiology can be represented.

Previously acquired patient images represent an important tool in radiology and related fields. Radiological professionals in part are trained by studying previously acquired images of previously diagnosed patients to teach radiology students how to recognize diseases and injuries in images of future patients. The need for compilations of previously acquired patient images, however, does not end with the professionals' initial training. After training, these professionals continue refer to collections of previously acquired images to help them diagnose conditions which potentially may be manifested in the images of future patients. Comparing and contrasting newly acquired images with collections of archived, previously acquired images is invaluable in directing or confirming patient diagnoses.

Invaluable as the principle of using previously acquired images might be, however, actually accessing and using archived image data presents a great problem. Merely confronting the overwhelming volume of data generated by these technologies can pose an ordeal. As with other computer graphics applications, medical imaging generates huge quantities of data, and a typical imaging study volume can range anywhere from 13 megabytes to 130 megabytes in size. Furthermore, countless numbers of archived imaging study volumes might exist for patients of all ages, having different illnesses, etc. Retrieving an analogous archived imaging study volume of a comparable patient and selecting relevant images for comparison with images of the target patient is a huge challenge.

Recognizing the importance of accessing previously acquired images, there have been attempts to exploit computer technology to enhance radiological professionals' ability to access relevant images. Some diagnostic workstations permit radiologists and other physicians to review a series of images from a previously acquired imaging study volume, and to manually select one or more key images from it. The problem with this manual method, not surprisingly, is that it is time consuming. In today's world, where skyrocketing healthcare costs encourage medical professionals to spend less time on individual patients rather than more, reviewing ever growing databases of imaging studies can be very costly.

Newer developments employ “prefetching” techniques which help use diagnostic information encoded and stored with the imaging study to retrieve imaging study volumes relevant to a current patient's potential disease or injury. However, while these prefetching techniques help to identify an image study volume of relevance to a diagnostic issue, these techniques do not identify the actual, key images within the image study volume that depict the lesion of interest. For example, an axial imaging study of a human brain may present fifty to sixty separate images taken along the images' transverse axis. Reviewing all of them to identify the five or six images depicting the specific view of interest again consumes the valuable time of trained diagnostic professionals.

Currently, anatomical imaging atlases are used as somewhat of a compromise. These atlases represent exemplary imaging studies organized by topic as a useful reference. Generally, these atlases are of two types. The first type is a “reference atlas,” which is derived from a single imaging scan. As the name implies, the exemplary scan is manually labeled to identify the structures represented in the images. Labeled reference atlases are typically used for teaching purposes, as well as for model-based segmentation.

The second type is a “probabilistic atlas” which comprises consolidated, averaged images of scans compiled from imaging scans of multiple subjects. Probabilistic atlases are used in model-based segmentation to track subtle morphological changes in structures across a target population. Creation of these composite images requires complex computation to elastically extrapolate the scans from several subjects to generate a common template. As compared to a labeled reference atlas, labeling structures on a probabilistic atlas is much more complicated: just as the constituent images themselves are averaged, the labels applied to the composite structures represented must be extrapolated as well.

Bearing in mind that the utility of these atlases is in being able to find relevant and being able to compare them with currently acquired images of a target patient, the usefulness of these atlases is limited by the properties of their selected images. Reference atlases typically are generated either at a single contrast setting or at a number of finite contrast settings. Unfortunately, the utility of fixed or finite contrast atlases for model-based segmentation is limited, because the patient images seldom manifest the identical contrast level as the atlas. For example, FIGS. 1A and 1B represent identical axial images of a human brain, except that the image 110 of the brain 120 depicted in FIG. 1A is presented with lower image intensity and contrast than the image 130 of the brain 140 depicted in FIG. 1B. The disparity in contrast impedes manual comparison of images, because even subtle differences in contrast sometimes are key indicators of medical phenomena.

The disparity in contrast presents even more of a problem in any attempt to automate the comparison process. Current attempts to automate the comparison of reference and target images commonly depend on intensity-based “registration” algorithms which require similar image intensities and contrast levels between the target images and the reference images. Most automated voxel registration algorithms are intensity-based and rely on the assumption that corresponding voxels in two compared volumes have equal intensity. This supposition is often referred to as the “intensity conservation assumption.” This assumption holds in rare cases where image acquisition parameters from an MRI or CT scan are identical between target images of a patient and a reference atlas. Most often, however the intensity conservation assumption does not old true for MRI volumes acquired with different coils and/or pulse sequences. In this and similar situations, differences in contrast between reference and target images impedes or completely invalidates the use of these common methods for image comparison by registration of the different volume sets.

What is needed is a way to both assist imaging professionals in retrieving relevant images from a patient study, as well as a way to adjust the intensity, contrast, image orientation, and other properties of the reference images to facilitate comparison with current patient images. It is to these needs that the present invention is directed.

### SUMMARY OF THE INVENTION

The present invention generates a customized reference atlas that matches the contrast and intensity of the target patient images. In one embodiment, the present invention automatically maps the target patient data to this customized atlas. Mapping allows the atlas data to be aligned spatially to the patient data. Accurate mapping of atlas to patient data acquired under a range of clinical protocols, such as varying contrast and intensity levels, is facilitated by the contrast/intensity customization of the atlas. In other embodiments, once the two volumes are aligned, the present invention then transfers the anatomical labels on the atlas to the patient data, labeling the patient data. In addition, the present invention further receives structured data concerning the condition with which the patient presents to infer the anatomy of interest where the suspected abnormality is located by applying expert rules stored in a knowledge base. Using the aligned and labeled reference atlas and the data describing the patient's condition, the present invention isolates representative labeled patient images of the inferred anatomy of interest for review by medical personnel.

### BRIEF DESCRIPTION OF THE DRAWINGS

FIG. 1A is an axial image of a human brain acquired at a particular setting of the imaging parameters.

FIG. 1B is an axial image of a human brain acquired at a different setting of the imaging parameters resulting in a contrast different from that of the image in FIG. 1A.

FIG. 2 is a flowchart of the processes used in the present invention.

FIG. 3 is a series of axial images of a human brain presented at many different levels of image intensity and contrast.

FIG. 4A is an axial image of a human brain presented with low image intensity and a histogram representing the intensity level.

FIG. 4B is an axial image of a human brain presented with higher image intensity and a histogram reflecting the intensity level.

FIG. 5 is a block diagram of an embodiment of a system of the present invention.

FIG. 6 is a representative screen of the user interface of an image study summarization module of a system of the present invention.

### DETAILED DESCRIPTION OF THE INVENTION

It will be appreciated that the method and system of the present invention can be applied to imaging studies of the pelvis, extremities, or other regions of a subject. Moreover, the subjects could be human, animal, or another entity from any other field in which diagnostic professionals could benefit from automatic extraction and customization of archived imaging studies for comparison with presently acquired target images. Embodiments of the present invention can be used with images acquired through magnetic resonance imaging, computed tomography scanning, or other imaging techniques.

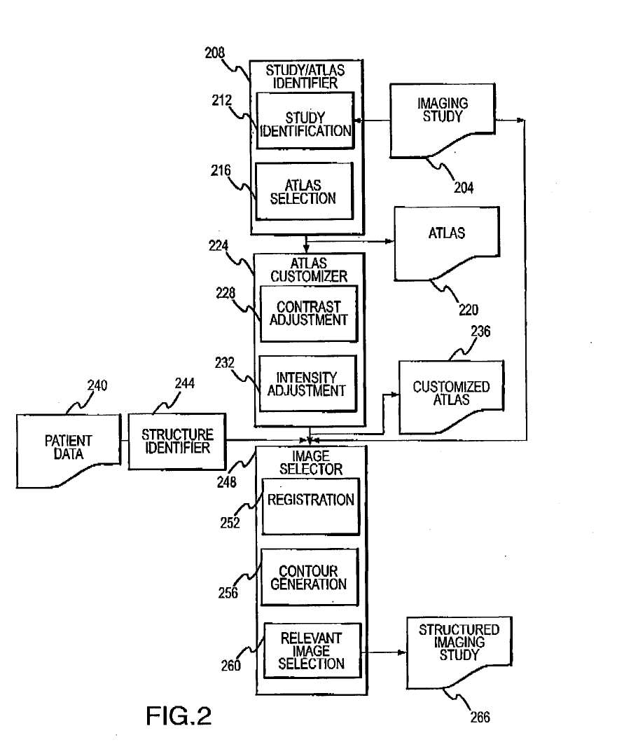

FIG. 2 is a flowchart of the processes used in one embodiment of the present invention. Naturally, before an embodiment of the present invention actually begins processing images, a patient imaging study 204 must be procured and submitted to the system. The images in this imaging volume 204 are both an input to the embodiment of the present invention, and may also form part of the output of an embodiment of the present invention, which will be subsequently appreciated.

The first process in the disclosed embodiment is the study/atlas identifier process 208. The study/atlas identifier process 208 localizes the images depicting the specific anatomical regions of interest in the appropriate image series. In a preferred embodiment, these anatomical regions are not localized through classic image segmentation, which defines the actual object boundary. Instead, a preferred embodiment localizes the anatomical regions by correlating the images to a labeled anatomy atlas to define a boundary box for the structure of interest. The labels used in the atlas to identify the structure are then applied to the patient image, thereby identifying and labeling structures within patient images.

The study/atlas identifier process 208 itself involves two primary subprocesses, a study identification subprocess 212 and an atlas selection subprocess 216. First, the study identification subprocess 212 reads and parses the “Digital Imaging and Communications in Medicine” or “DICOM” image header from the target patient's images. DICOM is the accepted standard for image transmission and communication. The format of the DICOM header includes image study and subject attributes. The header has a standard location and size assigned to each field, so that any DICOM complaint software can read the information stored in the study headers. The location and size of these attributes are standardized and published, and available through the World Wide Web at www.dicom.org. Most MRI and CT scan image acquisition devices are DICOM compatible.

The study identification process 212 extracts a number of the specifications encoded in the DICOM header, including the anatomical region imaged, the patient's age, the patient's gender, a diagnostic characterization of the patient, imaging modality, imaging geometry, and the image acquisition parameters used in capturing the images archived in the atlas. The imaging modality specifies the imaging technology used, whether MRI or CT scan. Data related to the patient age and anatomic region can be used to select images of the anatomical region of interest from an age-specific atlas appropriate for comparison with images captured from the current patient study. The imaging geometry allows for selection of an atlas acquired in an orientation similar to the images of the current patient study. Finally, the acquisition parameter values, such as the echo time (TE) and repetition time (TR) and the sequence type, such as FISP, SSFP, FLAIR, provide sufficient information to adapt the reference atlas images to match the image intensity and contrast of the patient images.

The second subprocess of the study/atlas identifier process 208 is the atlas selection subprocess 216. Once the study identification subprocess 212 has localized the context of the comparison, the atlas selection subprocess 216 actually selects an appropriate atlas 220 from the database. In one embodiment, this process uses an expert table-driven system. The tables are created by experts and stored in a knowledge base, and the tables map relevant parameters of the patient under examination to a relevant series of images archived in the atlas database. More specifically, the tables cross-reference the age, disease condition, and imaging modality of the patient under examination to select the appropriate atlas for comparing with the patient images.

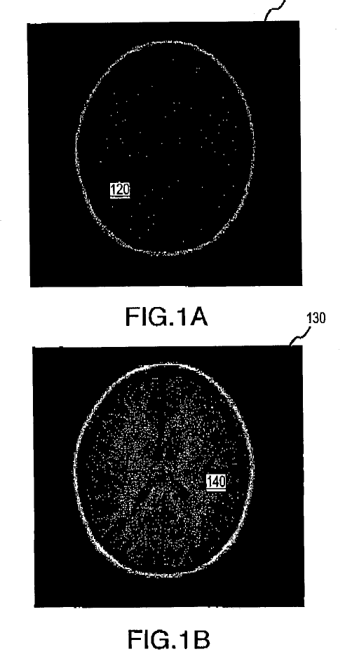

Once the study/atlas identifier process 204 identifies an appropriate atlas 220 from the database, the next process is the atlas customizer process 224. The final output of the customizer process is an atlas whose image intensity and contrast is similar to that of the images of the current patient study. As previously described with regard to FIGS. 1A and 1B, the properties of images acquired in imaging studies are highly significant, and vary greatly with changes in one or more of the image acquisition parameters. The alignment of the atlas and patient data sets is performed by a registration algorithm that operates on the assumption of “intensity conservation.” This assumption dictates that equivalent voxels in two different image sets have the same intensity. Conventionally, registration algorithms have been applied in controlled conditions where images in the reference atlas and patient images have been acquired under identical acquisition parameters. By contrast, embodiments of the present invention allow reference image data to be generalized to correspond with patient data acquired under a variety of clinical protocols by adjusting the intensity and contrast of the atlas images. Because having an ideal match between the patient images and the reference images is so important to align different image volumes to allow for meaningful comparisons, embodiments of the present invention can adjust the properties of atlas database images to match those of the patient images.

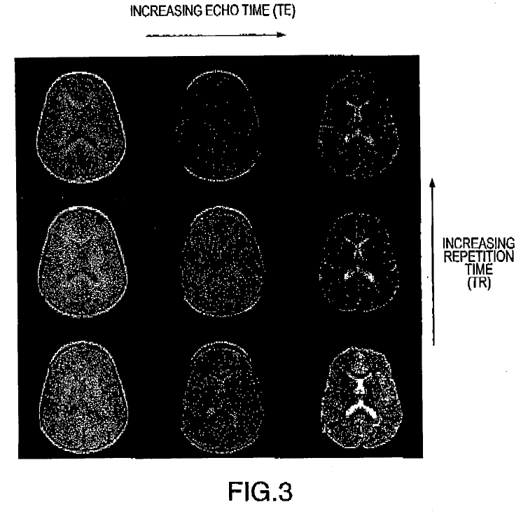

For example, FIG. 3 shows nine different renderings of the same image of a human brain. Even though each depicts the same subject, the images vary greatly in contrast because of changes in two of the image acquisition parameters. From left to right, echo time, TE, is increased, reducing image intensity. From bottom to top, repetition time, TR, is increased, reducing contrast. Changes in these two image acquisition parameters result in very different images. Further, depending on the region of the brain that is of interest, different image acquisition parameters yield better results than others. Accordingly, having flexibility in compensating for variations in the image acquisition parameters after the fact can be very helpful in making archived images more useful in comparing them with presently-acquired images from a target patient.

In the case of an MRI study, the atlas customization requires the generation of MR parameter maps including T1, T2, and proton-density parameters, from MR images acquired in a normal subject archived in the atlas database. Parameter maps of T1, T2, and proton density can be generated by acquiring images using commercially available saturation recovery spin echo and multi-echo fast spin echo sequences for T1 and T2 maps, respectively.

In one embodiment, T1 parametric data can generated from a saturation recovery spin echo sequence calculated by curve fitting to the saturation recovery equation:

$$S ( TR ) = k ( 1 - exp ( \frac{- TR}{T1} ) )$$

In this equation, S(TR) is the pixel signal intensity, the repetition time, TR, and T1 is the spin-lattice relaxation time. The constant k includes the proton density and T2 terms which do not change between the four images acquired at the same echo time, TE, but with varying TR values. For example, the following parameters can be used to generate T1 parametric data for a map of the brain: TE=20 ms; TR=200 to 2000 ms in 4 steps; slice thickness=1 mm; slice gap=0; field of view=240 mm×240 mm; and matrix size=256×256. T2 parametric mapping can be generated from a double-echo fast spin echo sequence by solving the T2 decay curve:

$$T2 = \frac{{TE}_{2} - {TE}_{1}}{ln ( \frac{{S}_{1}}{{S}_{2}} )}$$

In this equation, S1 is the pixel signal intensity at TE1, while S2 is the pixel intensity at TE2. For example, the following parameters can be used to derive the T2 map of the brain: TE=14,140 ms; TR=4000 ms; slice thickness=1 mm; slice gap=0; field of view =240 mm×240 mm; and matrix size=256×256. These equations are known in the art; the values supplied for the variables are typical, and are provided for clarity in illustration of how the equations are applied. From these parametric maps, images can be synthesized using the signal intensity relationships for Fast Spin Echo, 2D and 3D spoiled gradient echoes, 2D and 3D refocused gradient echoes, and ultrafast gradient echoes with and without magnetization preparation, which are clinical protocols known in the art.

Using the parametric data calculated, the atlas customizer process 224 involves two subprocesses: contrast adjustment 228 based on image synthesis, and intensity adjustment 232. First, in one embodiment, contrast adjustment 224 is performed using an MR image synthesis algorithm that enables new images to be synthesized at different values of the acquisition parameters TE, TR, and flip angle (FA). Again, FIG. 3 shows how resulting images can vary as a result of different acquisition values of echo time, TE, and repetition time, TR, even at the same spatial location. Contrast adjustment 224 allows for after-the-fact compensation of these image acquisition parameters to help equalize the contrast between the atlas and the target patient images.

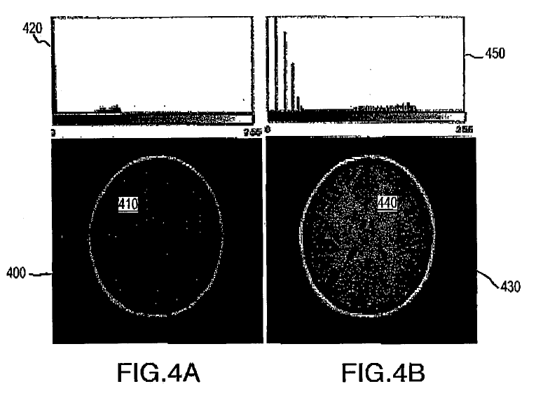

Second, intensity adjustment 232 is performed to better reconcile the patient images and the reference atlas images. In one embodiment, histogram equalization is used to spread pixel distribution equally among all the available intensities, resulting in a flatter histogram for each image. FIG. 4A shows an image 400 of an axial view of a brain 410, and an associated histogram 420 representing pixel intensity in the image 400. The horizontal axis of the histogram 420 reflects pixel intensity level, and the vertical axis reflects a number of pixels. Accordingly, the histogram reflects the number of pixels represented at each pixel density level. FIG. 4B shows an adjusted image 430 of the brain 440, the intensity of the image 430 being increased by adjusting the histogram 450 of the image 430. Each image was scaled to range between 0 and 255, so as to have a common dynamic range for the images from different subjects. The histogram of an MR volume usually consists of a peak corresponding to noise, followed by the peaks corresponding to brain tissue. Histograms of both the patient and atlas image volumes were examined for the location of the peak outside the noise region In sum, in the disclosed embodiment, the atlas customizer process 240 both selects comparable images from the atlas databases, and adjusts the image properties of the reference images to match those of the target patient images. The images are presented as a customized atlas 236 for patient age, image orientation, image contrast, and image intensity. The customized atlas 236 so generated would enhance the ability of medical personnel to manually compare patient images collected in the imaging study 204 with the customized atlas 236. The medical personnel could focus on the substantive features of the images without having to try to make their own allowances and extrapolations for image acquisition properties, because the atlas customizer process 224 has adjust those properties in the reference images to match those in the patient images.

In a preferred embodiment, an additional process further enhances the diagnostic process. The third major process is the image selector process 248 (FIG. 2). The inputs into this process are the patient's images from the target imaging study 204, the customized atlas 236 generated by the atlas customizer process 224, and structured data describing the patient subject of the imaging study 204. In one embodiment, a structured data entry, text-based identification system is used to gather patient data 240 submitted to the structure identifier 244 to identify the region of specific interest. Structured data entry can be menu driven, command driven, or use any other form of data entry to query the user as to the nature of the condition with which the patient under study presents. Successive menus, questions, or other means of eliciting user input can be presented to the user by the structure identifier 244 to identify with increasing specificity the region of interest. The menus and questions presented to the user are driven by an expert rule-based system designed to infer the location of the suspected abnormality, and the user's input in turn drives the processing of the expert rule-based system to present the user with successive menus and questions.

For example, if through successive responses to system queries, the user indicates that the patient presents with “chronic headache and neurological signs suspicious for hydrcephalus,” the expert rule-based system identifies that the anatomical region of interest is the lateral ventricles of the patient's brain. Responsive to that localization, the expert rule-based system would identify that the image series relevant to the user's examination would be a T1-weighted axial series. The system then automatically extracts the axial image from the present imaging study that has T1-weighted contrast and is at the level of the lateral ventricle.

With the imaging study 204, customized atlas 236, and patient data 240 as processed by the structure identifier 244 provided to the image selector process 248, the registration subprocess 252 performs the registration or alignment of the chosen atlas to the patient image data. This subprocess accesses an algorithm from a registration algorithm database and rules pertaining to the registration procedure itself from a registration selection rules knowledge-base. In a preferred embodiment, two registration algorithms are included in this subprocess. The first algorithm is a fast, automated principal-axes and moments-based alignment with a relatively low accuracy of registration. The second algorithm is an accurate three-dimensional automated voxel intensity-based algorithm. The registration subprocess 252 uses these algorithms to create a registration matrix that defines the spatial transformation required to equate the rotation, translation, and/or scaling between the target patient images and the customized atlas. The rotation, translation, and/or scaling are display parameters that affect how the images are actually presented to a user of the system. Both algorithms are known in the art. Both can be implemented in platform dependent mechanisms, or, in a preferred embodiment, by using a platform independent language, such as Java.

Once the registration subprocess 252 has aligned the image, the contour generation subprocess 256 uses the matrix outputted from the registration process 252 to identify the images from the target patient images containing the structure of interest as defined in the labeled customized atlas. As the image acquisition geometry is known for each image series in a study, the transformation matrix is also be used to identify the relevant structures in any series of a given study. Inputs to the contour generation subprocess 256 include the relevant regions and the relevant image series determined previously.

The final subprocess is the relevant image selection subprocess 260. The image selection subprocess 260 correlates with the patient images identified by the contour generation subprocess 256 with relevant comparison images drawn from the customized atlas 236 aligned with structure of interest in the patient study. The ultimate result is a structured imaging study 266 containing both relevant patient images and comparison images from the reference atlas database.

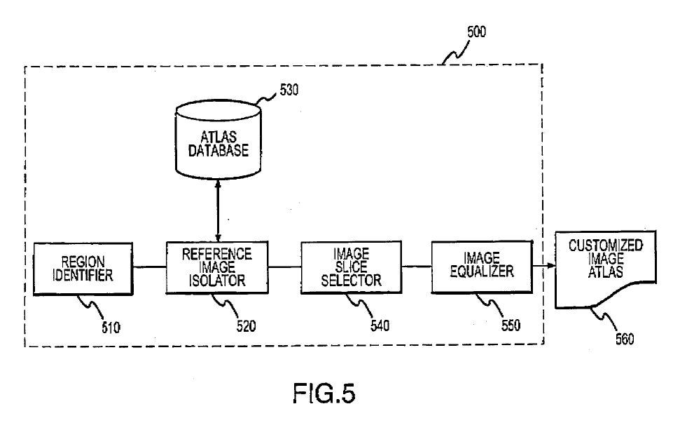

A customized atlas generating system 500 of the present invention is illustrated in FIG. 5. First, a region identifier 510 identifies the region of anatomical interest from which images are to be drawn for comparison with a target image. Second, once the region of interest has been identified, a reference image isolator 520 isolates relevant imaging studies from the atlas database 530. As previously described, a preferred embodiment of the invention isolates reference imaging studies from a like reference subject to render the most comparable images for comparison. The reference image isolator 520 attempts to identify reference imaging studies from reference subjects of similar age, gender, and other patient conditions, as well as attempting to isolate studies of similar imaging geometries and other imaging parameters. An image register (not shown), could also be used to execute the image selector processes 248 (FIG. 2) previously described to automate the selection of relevant comparison images between the reference and target images.

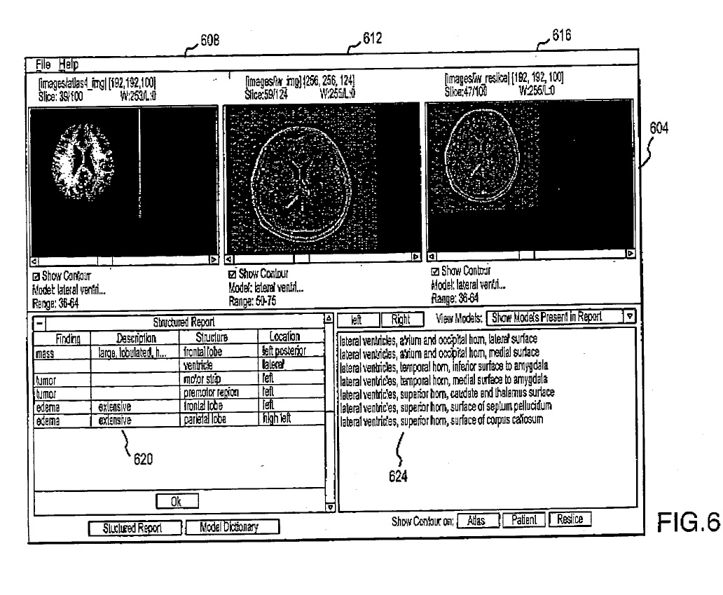

FIG. 6 shows a display screen from a preferred embodiment of the present invention. The top panel 604 shows three image stacks: the left most image stack 608 is the atlas used in the alignment algorithm. The central image 612 is the patient image data set, and the right image stack 616 is the patient data set aligned to match the atlas orientation. The structured report in the lower left panel 620 shows the list of suspected regions of abnormality. For example, the structure lateral ventricles, occipital horn is identified on the patient images as appearing on image slices 50-75. The image slices containing the structure are shown in the text field 624 ‘Range’ below the patient image stack. This identification was performed by registering the contrast/intensity customized labeled atlas to the patient image set and transferring the labels to the patient image stack. The reoriented patient set reoriented to the atlas is shown just as a guide to the accuracy of registration. FIG. 6 shows that, for the slice level shown, the atlas and reoriented patient images are well matched.

It is to be understood that, even though various embodiments and advantages of the present invention have been set forth in the foregoing description, the above disclosure is illustrative only. Changes may be made in detail, and yet remain within the broad principles of the invention. For example, although the disclosed embodiments employ particular processes to standardize contrast and intensity of the patient images, different image intensity standardization processes could be used.

1. A method for generating a customized imaging atlas comprising:
selecting a region of interest corresponding to a target image obtained from a target subject;
providing a plurality of reference images from the region of interest, the provided reference images being taken from at least one reference subject having a predetermined similarity to the target subject;
selecting one of the provided reference images, the selected reference image corresponding to the target image;
equalizing a contrast or a localized intensity of the selected reference image to match a contrast or a localized intensity, respectively, of a target image; and
adjusting a scale or an orientation of the selected reference image to match a scale or an orientation, respectively, of the target image.

2. The method of claim 1 wherein the localized intensity of the selected reference image is equalized using histogram equalization.

3. The method of claim 1 wherein the contrast of the selected reference image is equalized using image synthesis.

4. The method of claim 1 wherein the orientation of the selected reference image is adjusted using automated principal-axes and moments-based alignment.

5. The method of claim 1 wherein the orientation of the selected reference image is adjusted using a three-dimensional automated voxel intensity-based algorithm.

6. The method of claim 1 wherein the predetermined similarity to the target subject is at least one of imaging modality, imaging geometry, and image acquisition parameters used in capturing the provided reference images.

7. The method of claim 1 wherein the predetermined similarity to the target subject is age of the reference subject.

8. The method of claim 1 wherein the predetermined similarity to the target subject is gender of the reference subject.

9. The method of claim 1 wherein the predetermined similarity to the target subject is a diagnostic characterization of the reference subject.

10. The method of claim 1 wherein the predetermined similarity to the target subject desired of the at least one reference subject is identified by reviewing header information recorded with the target image.

11. The method of claim 1 further comprising comparing the target image to the selected reference image, whereby conditions which may be manifest in the target image can be diagnosed.

12. A method for generating a summarized imaging study for target images of a patient, comprising:
deriving a set of comparison reference images, comprising:
selecting a region of interest corresponding to a target image obtained from a target subject;
providing a plurality of reference images from the region of interest, the provided reference images being taken from at least one reference subject having a predetermined similarity to the target subject;
selecting one of the provided reference images, the selected reference image corresponding to the target image;
equalizing a contrast or a localized intensity of the selected reference image to match a contrast or a localized intensity, respectively, of a target image; and
adjusting a scale or an orientation of the selected reference image to match a scale or an orientation, respectively, of the target image; and
registering the target images and selected reference images by selecting at least one matching target image which correlates in the predetermined similarity with the selected reference image.

13. The method of claim 12 wherein the localized intensity of the selected reference image is equalized using histogram equalization.

14. The method of claim 12 wherein the contrast of the selected reference image is equalized using image synthesis.

15. The method of claim 12 wherein the orientation of the selected reference image is adjusted using automated principal-axes and moments-based alignment.

16. The method of claim 12 wherein the orientation of the selected reference image is adjusted using a three-dimensional automated voxel intensity-based algorithm.

17. The method of claim 12 wherein the predetermined similarity to the target subject is at least one of imaging modality, imaging geometry, and image acquisition parameters used in capturing the provided reference images.

18. The method of claim 12 wherein the predetermined similarity to the target subject is age of the reference subject.

19. The method of claim 12 wherein the predetermined similarity to the target subject is gender of the reference subject.

20. The method of claim 12 wherein the predetermined similarity to the target subject is a diagnostic characterization of the reference subject.

21. The method of claim 12 wherein the predetermined similarity to the target subject desired of the at least one reference subject is identified by reviewing header information recorded with the target image.

22. The method of claim 12 further comprising comparing the target image to the selected reference image, whereby conditions which may be manifest in the target image can be diagnosed.

23. The method of claim 12 wherein the predetermined similarity to the target subject desired of the at least one reference subject is identified based on expert rules that are applied to structured user input related to a presenting condition of the patient.

24. The method of claim 12 further comprising transferring labels applied to objects present in the reference images to the target images.

25. The method of claim 12 further comprising comparing the matching target image with the selected reference image, whereby conditions which may be manifest in the target image can be diagnosed.

26. A method for generating a customized imaging atlas comprising:
selecting a region of interest corresponding to a target image obtained from a target subject;
providing a plurality of reference images from the region of interest, the provided reference images being taken from at least one reference subject having a predetermined similarity to the target subject;
selecting one of the provided reference images, the selected reference image corresponding to the target image; and
equalizing a contrast or a localized intensity of the selected reference image to match a contrast or a localized intensity, respectively, of a target image.

27. The method of claim 26 wherein the localized intensity is equalized using histogram equalization.

28. The method of claim 26 wherein the contrast is equalized using image synthesis.

29. The method of claim 26 further comprising adjusting in the selected reference image a scale or an orientation to match to match a scale or an orientation, respectively, of the target image.

30. The method of claim 29 wherein the orientation is adjusted using automated principal-axes and moments-based alignment.

31. The method of claim 29 wherein the orientation is adjusted using a three-dimensional automated voxel intensity-based algorithm.

32. The method of claim 26 wherein the predetermined similarity to the target subject is age of the reference subject.

33. The method of claim 26 wherein the predetermined similarity to the target subject is gender of the reference subject.

34. The method of claim 26 wherein the predetermined similarity to the target subject is a diagnostic characterization of the reference subject.

35. The method of claim 26 wherein the predetermined similarity to the target subject desired of the at least one reference subject is identified by reviewing header information recorded with the target image.

36. The method of claim 26 further comprising comparing the target image to the selected reference image, whereby conditions which may be manifest in the target image can be diagnosed.

37. A method for generating a summarized imaging study for target images of a patient, comprising:
deriving a set of comparison reference images, comprising:
selecting a region of interest corresponding to a target image obtained from a target subject;
providing a plurality of reference images from the region of interest, the provided reference images being taken from at least one reference subject having a predetermined similarity to the target subject;
selecting one of the provided reference images, the selected reference image corresponding to the target image; and
equalizing a contrast or a localized intensity of the selected reference image to match a contrast or a localized intensity, respectively, of a target image; and
registering the target images and selected reference images by selecting at least one matching target image which correlates in the predetermined similarity with the selected reference image.

38. The method of claim 37 wherein the localized intensity is equalized using histogram equalization.

39. The method of claim 37 wherein the contrast is equalized using image synthesis.

40. The method of claim 37 further comprising adjusting in the selected reference image a scale or an orientation to match to match a scale or an orientation, respectively, of the target image.

41. The method of claim 40 wherein the orientation is adjusted using automated principal-axes and moments-based alignment.

42. The method of claim 40 wherein the orientation is adjusted using a three-dimensional automated voxel intensity-based algorithm.

43. The method of claim 37 wherein the predetermined similarity to the target subject is age of the reference subject.

44. The method of claim 37 wherein the predetermined similarity to the target subject is gender of the reference subject.

45. The method of claim 37 wherein the predetermined similarity to the target subject is a diagnostic characterization of the reference subject.

46. The method of claim 37 wherein the predetermined similarity to the target subject desired of the at least one reference subject is identified by reviewing header information recorded with the target image.

47. The method of claim 37 further comprising comparing the target image to the selected reference image, whereby conditions which may be manifest in the target image can be diagnosed.

48. The method of claim 37 wherein the predetermined similarity to the target subject desired of the at least one reference subject is identified by reviewing header information recorded with the target image.

49. The method of claim 37 wherein the predetermined similarity to the target subject desired of the at least one reference subject is identified based on expert rules that are applied to structured user input related to a presenting condition of the patient.

50. The method of claim 37 further comprising transferring labels applied to objects present in the reference images to the target images.

51. The method of claim 37 further comprising comparing the matching target image with the selected reference image, whereby conditions which may be manifest in the target image can be diagnosed.

52. A method for generating a customized imaging atlas comprising:
selecting a region of interest corresponding to a target image obtained from a target subject;
providing a plurality of reference images from the region of interest, the provided reference images being taken from at least one reference subject having a predetermined similarity to the target subject;
selecting one of the provided reference images, the selected reference image corresponding to the target image; and
adjusting a scale or an orientation of the selected reference image to match a scale or an orientation, respectively, of the target image.

53. The method of claim 52 wherein the orientation is adjusted using automated principal-axes and moments-based alignment.

54. The method of claim 52 wherein the orientation is adjusted using a three-dimensional automated voxel intensity-based algorithm.

55. The method of claim 52 further comprising equalizing in the selected reference image a contrast or a localized intensity to match a contrast or a localized intensity, respectively, of the target image.

56. The method of claim 52 wherein the localized intensity is equalized using histogram equalization.

57. The method of claim 55 wherein the contrast is equalized using image synthesis.

58. The method of claim 52 wherein the predetermined similarity to the target subject is age of the reference subject.

59. The method of claim 52 wherein the predetermined similarity to the target subject is gender of the reference subject.

60. The method of claim 52 wherein the predetermined similarity to the target subject is a diagnostic characterization of the reference subject.

61. The method of claim 52 wherein the predetermined similarity to the target subject desired of the at least one reference subject is identified by reviewing header information recorded with the target image is identified by reviewing header information in the target image.

62. The method of claim 52 further comprising comparing the target image to the selected reference image, whereby conditions which may be manifest in the target image can be diagnosed.

63. A method for generating a summarized imaging study for target images of a patient, comprising:
deriving a set of comparison reference images, comprising:
selecting a region of interest corresponding to a target image obtained from a target subject;
providing a plurality of reference images from the region of interest, the provided reference images being taken from at least one reference subject having a predetermined similarity to the target subject;
selecting one of the provided reference images, the selected reference image corresponding to the target image; and
adjusting a scale or an orientation of the selected reference image to match a scale or an orientation, respectively, of the target image; and
registering the target images and selected reference images by selecting at least one matching target image which correlates in the predetermined similarity with the selected reference image.

64. The method of claim 63 wherein the orientation is adjusted using automated principal-axes and moments-based alignment.

65. The method of claim 63 wherein the orientation is adjusted using a three-dimensional automated voxel intensity-based algorithm.

66. The method of claim 63 further comprising equalizing in the selected reference image a contrast or a localized intensity to match a contrast or a localized intensity, respectively, of the target image.

67. The method of claim 63 wherein the localized intensity is equalized using histogram equalization.

68. The method of claim 63 wherein the contrast is equalized using image synthesis.

69. The method of claim 63 wherein the predetermined similarity to the target subject is age of the reference subject.

70. The method of claim 63 wherein the predetermined similarity to the target subject is gender of the reference subject.

71. The method of claim 63 wherein the predetermined similarity to the target subject is a diagnostic characterization of the reference subject.

72. The method of claim 63 wherein the predetermined similarity to the target subject desired of the at least one reference subject is identified by reviewing header information recorded with the target image is identified by reviewing header information in the target image.

73. The method of claim 63 further comprising comparing the target image to the selected reference image, whereby conditions which may be manifest in the target image can be diagnosed.

74. The method of claim 63 wherein the predetermined similarity to the target subject desired of the at least one reference subject is identified based on expert rules that are applied to structured user input related to a presenting condition of the patient.

75. The method of claim 63 further comprising transferring labels applied to objects present in the reference images to the target images.

76. The method of claim 63 further comprising comparing the matching target image with the selected reference image, whereby conditions which may be manifest in the target image can be diagnosed.

77. A method for generating a customized imaging atlas comprising:
selecting a region of interest corresponding to a target image obtained from a target subject;
providing a plurality of reference images from the region of interest, the provided reference images being taken from at least one reference subject having a predetermined similarity to the target subject;
selecting one of the provided reference images, the selected reference image corresponding to the target image;
equalizing at least one characteristic of the selected reference image to match a contrast or a localized intensity, respectively, of a target image; and
adjusting a scale or an orientation of the selected reference image to match a corresponding characteristic of the target image.

78. The method of claim 77 wherein the characteristic is contrast.

79. The method of claim 78 wherein the contrast is equalized using image synthesis.

80. The method of claim 77 wherein the characteristic is localized intensity.

81. The method of claim 80 wherein the localized intensity is equalized using histogram equalization.

82. The method of claim 77 wherein the characteristic is scale.

83. The method of claim 77 wherein the characteristic is orientation.

84. The method of claim 83 wherein the orientation is equalized using automated principal-axes and moments-based alignment.

85. The method of claim 83 wherein the orientation is equalized using a three-dimensional automated voxel intensity-based algorithm.

86. The method of claim 77 wherein the predetermined similarity to the target subject is at least one of imaging modality, imaging geometry, and image acquisition parameters used in capturing the provided reference images.

87. The method of claim 77 wherein the predetermined similarity to the target subject is age of the reference subject.

88. The method of claim 77 wherein the predetermined similarity to the target subject is gender of the reference subject.

89. The method of claim 77 wherein the predetermined similarity to the target subject is a diagnostic characterization of the reference subject.

90. The method of claim 77 wherein the predetermined similarity to the target subject desired of the at least one reference subject is identified by reviewing header information recorded with the target image.

91. The method of claim 77 further comprising comparing the target image to the selected reference image, whereby conditions which may be manifest in the target image can be diagnosed.

92. A method for generating a summarized imaging study for target images of a patient, comprising:
deriving a set of comparison reference images, comprising:
selecting a region of interest corresponding to a target image obtained from a target subject;
providing a plurality of reference images from the region of interest, the provided reference images being taken from at least one reference subject having a predetermined similarity to the target subject;
selecting one of the provided reference images, the selected reference image corresponding to the target image;
equalizing at least one characteristic of the selected reference image to match a contrast or a localized intensity, respectively, of a target image; and
adjusting a scale or an orientation of the selected reference image to match a corresponding characteristic of the target image; and
registering the target images and selected reference images by selecting at least one matching target image which correlates in the predetermined similarity with the selected reference image.

93. The method of claim 92 wherein the characteristic is contrast.

94. The method of claim 93 wherein the contrast is equalized using image synthesis.

95. The method of claim 92 wherein the characteristic is localized intensity.

96. The method of claim 95 wherein the localized intensity is equalized using histogram equalization.

97. The method of claim 92 wherein the characteristic is scale.

98. The method of claim 92 wherein the characteristic is orientation.

99. The method of claim 98 wherein the orientation is equalized using automated principal-axes and moments-based alignment.

100. The method of claim 98 wherein the orientation is equalized using a three-dimensional automated voxel intensity-based algorithm.

101. The method of claim 92 wherein the predetermined similarity to the target subject is at least one of imaging modality, imaging geometry, and image acquisition parameters used in capturing the provided reference images.

102. The method of claim 92 wherein the predetermined similarity to the target subject is age of the reference subject.

103. The method of claim 92 wherein the predetermined similarity to the target subject is gender of the reference subject.

104. The method of claim 92 wherein the predetermined similarity to the target subject is a diagnostic characterization of the reference subject.

105. The method of claim 92 wherein the predetermined similarity to the target subject desired of the at least one reference subject is identified by reviewing header information recorded with the target image.

106. The method of claim 92 further comprising comparing the target image to the selected reference image, whereby conditions which may be manifest in the target image can be diagnosed.

107. The method of claim 92 wherein the predetermined similarity to the target subject desired of the at least one reference subject is identified based on expert rules that are applied to structured user input related to a presenting condition of the patient.

108. The method of claim 92 further comprising transferring labels applied to objects present in the reference images to the target images.

109. The method of claim 92 further comprising comparing the matching target image with the selected reference image, whereby conditions which may be manifest in the target image can be diagnosed.

110. A customized imaging atlas generating system comprising:
a collection of reference images obtained from a region of interest corresponding to a region from which a target image was obtained;
a reference image selector selecting references images in the collection obtained from at least one reference subject having a predetermined similarity to a target subject;
an image identifier coupled to the image selector, the image identifier comparing the target image to the selected reference images and identifying one of the selected reference images based on the comparison; and
an image equalizer coupled to the image identifier, the image equalizer equalizing at least one characteristic of the identified reference image to match a corresponding characteristic of the target image.

111. The system of claim 110 wherein the image equalizer equalizes localized intensity.

112. The system of claim 110 wherein the image equalizer equalizes localized intensity using histogram equalization.

113. The system of claim 1 10 wherein the image equalizer equalizes contrast.

114. The system of claim 110 wherein the image equalizer equalizes contrast using image synthesis.

115. The system of claim 110 wherein the image equalizer equalizes orientation.

116. The system of claim 110 wherein the image equalizer equalizes orientation using automated principal-axes and moments-based alignment.

117. The system of claim 110 wherein the image equalizer equalizes orientation using a three-dimensional automated voxel intensity-based algorithm.

118. The system of claim 110 wherein the reference image selector selects the selected reference images according to at least one of imaging modality, imaging geometry, and image acquisition parameters used in capturing the reference images.

119. The system of claim 110 wherein the reference image selector selects the selected reference images according to the predetermined similarity of age of the reference subject.

120. The system of claim 110 wherein the reference image selector selects the selected reference images according to the predetermined similarity of gender of the reference subject.

121. The system of claim 110 wherein the reference image selector selects the selected reference images according to the predetermined similarity of a diagnostic characterization of the reference subject.

122. The system of claim 110 wherein the reference image selector selects the selected reference images according to the predetermined similarity determined by reviewing header information recorded with the target image.

123. The system of claim 110 further comprising an image comparator receptive of the target image and the reference images, the image comparator comparing the target image with to the selected reference image, whereby conditions which may be manifest in the target image can be diagnosed.

124. An system for generating a summarizing image study for target images of a patient, comprising:
a collection of reference images obtained from a region of interest corresponding to a region from which a target image was obtained;
a reference image selector selecting references images in the collection obtained from at least one reference subject having a predetermined similarity to a target subject;
an image identifier coupled to the image selector, the image identifier comparing the target image to the selected reference images and identifying one of the selected reference images based on the comparison;
an image equalizer coupled to the image identifier, the image equalizer equalizing at least one characteristic of the identified reference image to match a corresponding characteristic of the target image; and
an image register coupled to the image equalizer and receiving the target images and, the image register selecting at least one matching target image which correlates in the predetermined similarity with the selected reference image.

125. The system of claim 124 wherein the image equalizer equalizes localized intensity.

126. The system of claim 124 wherein the image equalizer equalizes localized intensity using histogram equalization.

127. The system of claim 124 wherein the image equalizer equalizes contrast.

128. The system of claim 124 wherein the image equalizer equalizes contrast using image synthesis.

129. The system of claim 124 wherein the image equalizer equalizes orientation.

130. The system of claim 124 wherein the image equalizer equalizes orientation using automated principal-axes and moments-based alignment.

131. The system of claim 124 wherein the image equalizer equalizes orientation using a three-dimensional automated voxel intensity-based algorithm.

132. The system of claim 124 wherein the reference image selector selects the selected reference images according to at least one of imaging modality, imaging geometry, and image acquisition parameters used in capturing the reference images.

133. The system of claim 124 wherein the reference image selector selects the selected reference images according to the predetermined similarity of age of the reference subject.

134. The system of claim 124 wherein the reference image selector selects the selected reference images according to the predetermined similarity of gender of the reference subject.

135. The system of claim 124 wherein the reference image selector selects the selected reference images according to the predetermined similarity of a diagnostic characterization of the reference subject.

136. The system of claim 124 wherein the reference image selector selects the selected reference images according to the predetermined similarity determined by reviewing header information recorded with the target image.

137. The system of claim 125 further comprising an image comparator receptive of the target image and the reference images, the image comparator comparing the target image with to the reference images, whereby conditions which may be manifest in the target image can be diagnosed.

138. The system of claim 125 further comprising an expert rules knowledgebase coupled to the image register and receiving the target images and patient presenting information entered into a patient information device, wherein the expert rules knowledgebase identifies the predetermined similarity to the target subject desired of the at least one reference subject based on expert rules that are applied to structured user input related to a presenting information entered in the patient information device.

139. The system of claim 125 further comprising a label transfer device coupled to the image register and receiving the target images, the label transfer device transferring labels applied to objects present in the selected reference images to the target images.

140. The system of claim 125 further comprising an image comparator receptive of the target image and the selected reference image, the image comparator comparing the target image with to the selected reference image, whereby conditions which may be manifest in the target image can be diagnosed.
